(19) United States
(12) Patent Application Publication
(10) Pub. No.: US 2026/0264859 A1
(43) Pub. Date: Sep. 10, 2026

(54) BRACKETS, ASSEMBLIES, AND METHODS FOR AIRCRAFT INTERIOR STRUCTURES

(71) Applicant: The Boeing Company, Arlington, VA (US)

(72) Inventors: Edward H. Chue, Bellevue, WA (US); Andrew A. Boyles, Corvallis, OR (US)

(21) Appl. No.: 19/073,569

(22) Filed: Mar. 7, 2025

(51) Int. Cl. B64D 11/00

(52) U.S. Cl. CPC B64D 11/003

(57) ABSTRACT

Brackets for coupling two panels together at an angle comprise a first wall having a first-wall inner face and a first-wall outer face opposite the first-wall inner face, a second wall having a second-wall inner face and a second-wall outer face opposite the second-wall inner face, and a hollow projection extending from the first-wall inner face. The second-wall inner face extends at the angle to the first-wall inner face. The second wall defines a second-wall fastener hole extending through the second wall. The hollow projection defines a projection fastener hole extending through the hollow projection and co-axially aligned with the second-wall fastener hole.

### FIELD

The present disclosure relates to the assembly of aircraft interiors.

### BACKGROUND

Aircraft interiors are often constructed using sandwich panels due to their high strength-to-mass ratio. However, aircraft interior structures constructed of sandwich panels, such as stowage bins, closets, lavatories, shelving units, interior bulkheads, crew rest compartments, and the like typically require significant assembly time that utilizes liquid adhesives that require clean-up. Such aircraft interior structures are often constructed utilizing mortise-and-tenon joints or potted inserts, whose quality and structural integrity largely depend on operator skill and diligence. Because aircraft interior structures must meet stringent FAA requirements for strength, maintaining the high-quality standards required for structural integrity is a production challenge. Moreover, such aircraft interior structures with mortise-and-tenon construction cannot be dissembled and sandwich panels cannot be easily replaced. Accordingly, discovery of quality issues after construction or installation of aircraft interior structures may require significant rework and scrapping of expensive components.

### SUMMARY

Brackets for coupling two panels together at an angle comprise a first wall, a second wall, and a hollow projection. The first wall has a first-wall inner face and a first-wall outer face opposite the first-wall inner face. The second wall has a second-wall inner face and a second-wall outer face opposite the second-wall inner face. The second-wall inner face extends at the angle to the first-wall inner face. The second wall defines a second-wall fastener hole extending through the second wall. The hollow projection extends from the first-wall inner face and defines a projection fastener hole extending through the hollow projection and co-axially aligned with the second-wall fastener hole. Methods of manufacturing the bracket comprise injection-molding the bracket.

Assemblies comprise the bracket, a first panel, a second panel, and a male fastener. The first panel is engaged with the first-wall inner face. The first panel defines a first-panel projection slot, through which the hollow projection extends. The second panel is engaged with the second-wall inner face and defines a second-panel fastener hole co-axially aligned with the second-wall fastener hole and the projection fastener hole. The male fastener extends through the second-wall fastener hole, the second-panel fastener hole, and the projection fastener hole.

Methods of assembling the assembly comprise inserting the hollow projection through the first-panel projection slot such that the first panel engages the first-wall inner face, engaging the second panel with the second-wall inner face and with the first panel, inserting the male fastener through the second-wall fastener hole, the second-panel fastener hole, and the projection fastener hole, and securing the male fastener in place.

### BRIEF DESCRIPTION OF THE DRAWINGS

FIG. 1 is an illustration of an example aircraft.

FIG. 2 is an illustration of an example aircraft interior.

FIG. 3 is a schematic illustration representing brackets and assemblies according to the present disclosure.

FIG. 4 is a schematic illustration representing hollow projections of brackets according to the present disclosure.

FIG. 5 is an isometric view of an example bracket according to the present disclosure.

FIG. 6 is a front view of the example bracket of FIG. 5.

FIG. 7 is a rear view of the example bracket of FIG. 5.

FIG. 8 is a top view of the example bracket of FIG. 5.

FIG. 9 is a bottom view of the example bracket of FIG. 5.

FIG. 10 is a side view of the example bracket of FIG. 5.

FIG. 11 is an exploded isometric view of an example assembly with the example bracket of FIG. 5.

FIG. 12 is an isometric view of the example assembly of FIG. 11.

FIG. 13 is an isometric view of another example bracket according to the present disclosure.

FIG. 14 is a front view of the example bracket of FIG. 13.

FIG. 15 is a rear view of the example bracket of FIG. 13.

FIG. 16 is a top view of the example bracket of FIG. 13.

FIG. 17 is a bottom view of the example bracket of FIG. 13.

FIG. 18 is a side view of the example bracket of FIG. 13.

### DESCRIPTION

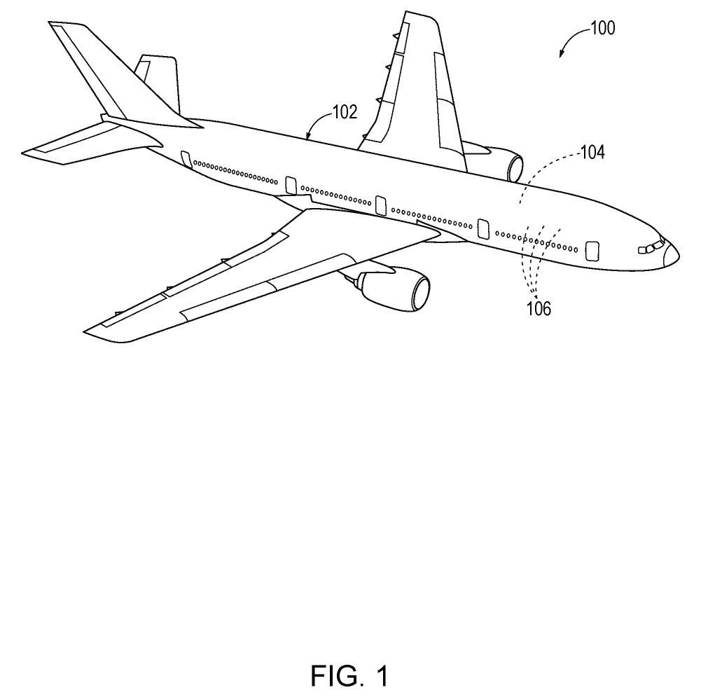

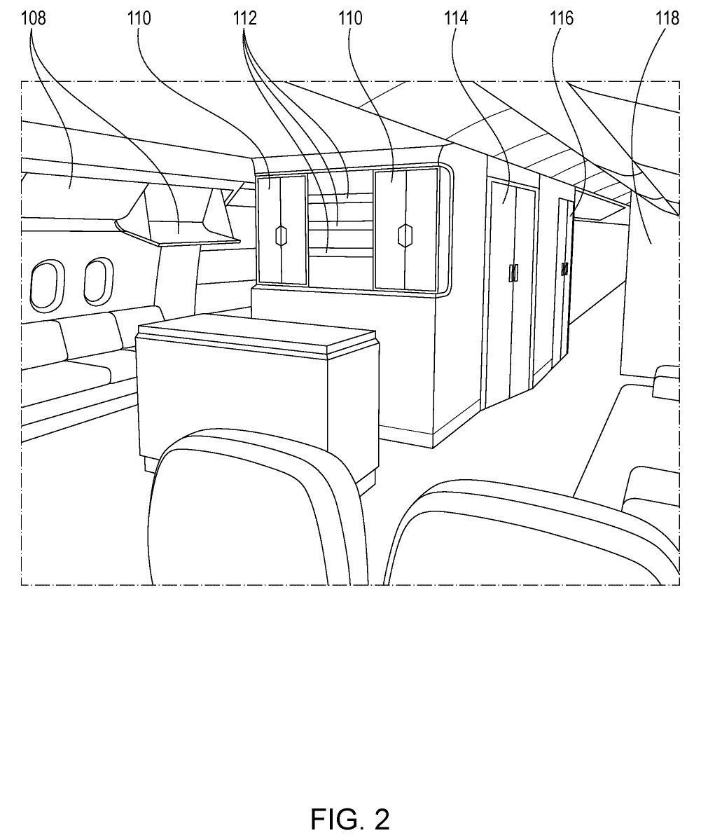

With initial reference to FIG. 1, aircraft 100 according to the present disclosure comprise a fuselage 102 that defines an interior 104 and typically one or more aerospace assemblies 106 positioned within the interior 104. FIG. 2 illustrates an example interior 104 with various example aerospace assemblies 106 including aircraft stowage bins 108, aircraft closets or cabinets 110, an aircraft shelving unit 112, an aircraft crew rest compartment 114, an aircraft lavatory 116, and an aircraft interior bulkhead 118. One or more of such aerospace assemblies 106 of an aircraft 100 may comprise an assembly 62 according to the present disclosure that comprises one or more brackets 10 according to the present disclosure.

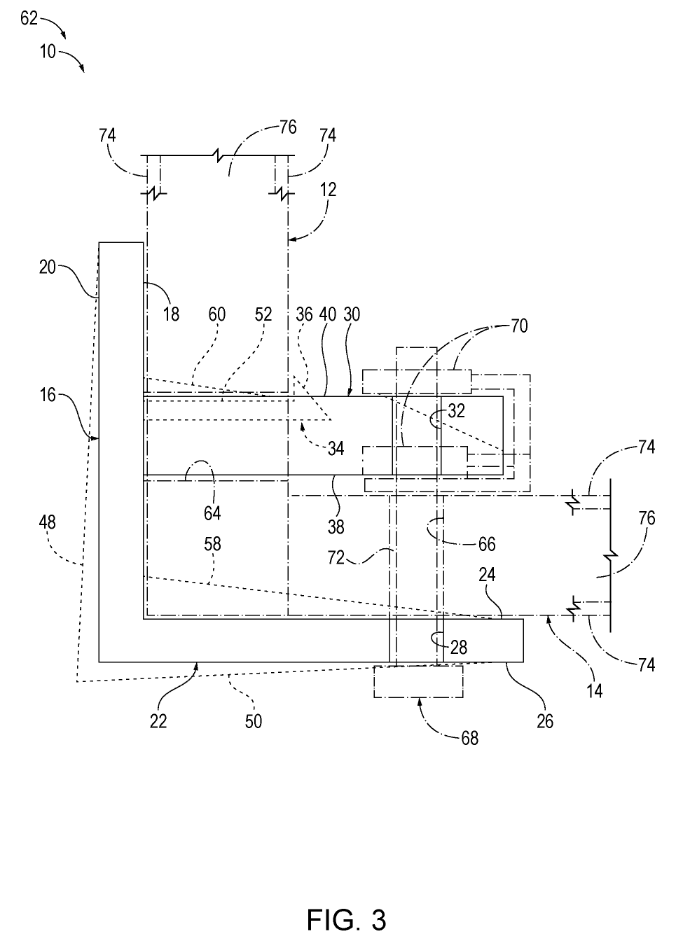

FIGS. 3 and 4 schematically represent brackets 10 and assemblies 62 according to the present disclosure. Generally, in FIGS. 3 and 4, elements that are likely to be included in a given example are illustrated in solid lines, while elements that are optional to a given example or that correspond to one or more specific examples are illustrated in broken lines. However, elements that are illustrated in solid lines are not essential to all examples of the present disclosure, and an element shown in solid lines may be omitted from a particular example without departing from the scope of the present disclosure.

With reference to FIG. 3, brackets 10 for coupling a first panel 12 to a second panel 14 at an angle. In some examples, the angle is a right angle. Herein, a right angle is an angle of 90° or approximately 90°, such as within typical manufacturing tolerances for brackets 10. In some assemblies 62, the first panel 12 and the second panel 14 are sandwich panels, such as each comprising opposing face sheets 74 and a honeycomb core 76.

As schematically represented in FIG. 3, brackets 10 comprise a first wall 16, a second wall 22, and a hollow projection 30. The first wall 16 has a first-wall inner face 18 and a first-wall outer face 20 that is opposite the first-wall inner face 18. The second wall 22 has a second-wall inner face 24 and a second-wall outer face 26 opposite the second-wall inner face 24. The second-wall inner face 24 extends at the angle to the first-wall inner face 18, and the second wall 22 defines a second-wall fastener hole 28 that extends through the second wall 22. The hollow projection 30 extends from the first-wall inner face 18 and defines a projection fastener hole 32 that extends through the hollow projection 30 and that is co-axially aligned with the second-wall fastener hole 28.

Assemblies 62 comprise the bracket 10, the first panel 12, the second panel 14, and a male fastener 68 (e.g., a bolt or other threaded male fastener). In FIG. 3, the first panel 12, the second panel 14, and the male fastener 68 are schematically represented in dash-dot lines as environment to the bracket 10. However, in assemblies 62, the first panel 12, the second panel 14, and the male fastener 68 are present. In assemblies 62, the first panel 12 is engaged with the first-wall inner face 18 of the bracket 10. In assemblies 62, the first panel 12 defines a first-panel projection slot 64, through which the hollow projection 30 of the bracket 10 extends. In assemblies 62, the second panel 14 is engaged with the second-wall inner face 24 of the bracket 10. In assemblies 62, the second panel 14 defines a second-panel fastener hole 66 that is co-axially aligned with the second-wall fastener hole 28 and with the projection fastener hole 32. In assemblies 62, the male fastener 68 extends through the second-wall fastener hole 28, the second-panel fastener hole 66, and the projection fastener hole 32. In some examples, assemblies 62 further comprise a female fastener 70, such as a nut, a nut clip, a barrel nut, a captive nut, or an ultrasonic insert that operatively mates with the male fastener 68. Some assemblies 62 further comprise a bushing 72 that is positioned within the second-panel fastener hole 66, with the male fastener 68 extending therethrough. When present, the bushing 72 may protect the integrity of the surface(s) of the second panel 14 that defines the second-panel fastener hole 66.

Methods of assembling assemblies 62 comprise inserting the hollow projection 30 of the bracket 10 through the first-panel projection slot 64 such that the first panel 12 engages the first-wall inner face 18, engaging the second panel 14 with the second-wall inner face 24 of the bracket 10 and with the first panel 12, inserting the male fastener 68 through the second-wall fastener hole 28, the second-panel fastener hole 66, and the projection fastener hole 32, and securing the male fastener 68 in place.

Accordingly, the hollow projection 30 of brackets 10 provides structure transferring shear and moment loads from the second panel 14 to the first panel 12, thereby operatively maintaining the first panel 12 in relation to the second panel 14. Moreover, the hollow projection 30 provides structure for the male fastener 68 to operatively secure the second panel 14 in place. Therefore, when brackets 10 are manufactured within desired tolerances, brackets 10 provide for secure assembly of the first panel 12 and the second panel 14 within an assembly 62 without the need for liquid adhesives.

As schematically represented in FIG. 3, some brackets 10 further comprise a cantilever clip 34 that extends away from the first-wall inner face 18 and that is configured to interface with the first panel 12 for operatively maintaining the first panel 12 in engagement with the first-wall inner face 18 of the bracket 10. In some examples, the cantilever clip 34 comprises a hook 36 that extends away from the second-wall inner face 24 for operative engagement with the first panel 12. The hook 36 additionally or alternatively may be described as a barb 36, and the cantilever clip 34 may be described as having a snap-fit arrangement with the first panel 12. That is, in some assemblies 62, the hook 36 engages the first panel 12 opposite the first-wall inner face 18.

The hollow projection 30 is hollow, such as constructed from a thin wall of material. Accordingly, the hollow projection 30 provides a higher strength-to-mass ratio than an otherwise solid projection of the same mass.

The hollow projection 30 may be described as having a projection profile when viewed from its end (i.e., when facing the first-wall inner face 18). Similarly, in assemblies 62, the first-panel projection slot 64 through which the hollow projection 30 extends may be described as having a projection-hole profile that is concentric with the projection profile. In some examples of assemblies 62, the hollow projection 30 is in a slip-fit arrangement (i.e., in close proximity and engaged) with the surface or surfaces of the first panel 12 that define the first-panel projection slot 64. In some examples of assemblies 62, the hollow projection 30 is in a friction-fit arrangement (i.e., tight fit) with the surface or surfaces of the first panel 12 that define the first-panel projection slot 64. Accordingly, in such examples, the hollow projection 30 serves to operatively maintain the first panel 12 in a fixed position relative to the bracket 10.

With reference to FIG. 4, in some examples, the hollow projection 30 comprises a projection lower face 38 that faces the second-wall inner face 24, a projection upper face 40 that is opposite the projection lower face 38 and that faces away from the second-wall inner face 24, a projection left face 42 that extends between the projection lower face 38 and the projection upper face 40, and a projection right face 44 that is opposite the projection left face 42 and that extends between the projection lower face 38 and the projection upper face 40. Accordingly, the hollow projection 30 may be described as having a generally quadrilateral profile. In some examples, the hollow projection 30 has a generally trapezoidal profile, and in some examples, it has a generally isosceles trapezoidal profile. By generally quadrilateral or trapezoidal, it is meant that the profile of the hollow projection 30 may not be a perfect polygon with sharp edges and/or perfectly planar walls. Rather, the edges of the projection (i.e., the corners of the profile) may be curved or rounded, and the faces of the projection may not be uniform or otherwise extend across an entirety of a side of the projection.

With continued reference to FIG. 4, the projection lower face 38 may be described as having a lower-face width 46, and the projection upper face 40 may be described as having an upper-face width 49. In some examples, the lower-face width 46 is less than the upper-face width 49. In such examples, in assemblies 62, the load transfer from the hollow projection 30 to the first panel 12 will be concentrated away from the edge of the first panel 12. Moreover, the large area of the hollow projection 30 in contact with the first-panel projection slot 64 lowers the bearing stress in the face sheets 74, thereby enabling effective transfer or shear and moment forces.

With continued reference to FIG. 4, in some examples, the projection upper face 40 defines a gap 54, and the cantilever clip 34 extends within the gap 54. Accordingly, in such examples, the cantilever clip 34 is positioned to operatively engage the first panel 12 opposite the first-wall inner face 18. The cantilever clip 34 may be described as having a cantilever-clip upper face 52, and in some examples, as schematically represented in FIG. 3, the cantilever-clip upper face 52 is co-planar with and/or parallel to the projection upper face 40. Accordingly, in examples that include a hook 36, the hook need not be very long, thereby reducing the force required to insert the hollow projection 30 into and through the first-panel projection slot 64 and decreasing the opportunity for the hook 36 to break.

As schematically represented in dashed lines in FIG. 3, in some examples, the projection lower face 38 extends further from the first-wall inner face 18 than the projection upper face 40. In some such examples, the projection fastener hole 32 extends through the projection lower face 38 but not through the projection upper face 40. Accordingly, in such examples, access to the male fastener 68 with the female fastener 70 is facilitated. In addition, less material is utilized, thereby reducing the mass of the bracket 10.

With continued reference to FIG. 3, in some examples, brackets 10 further comprise one or more first-wall reinforcing ribs 48 that extend from the first-wall outer face 20 and/or one or more second-wall reinforcing ribs 50 extending from the second-wall outer face 26. As implied, when present, the reinforcing ribs stiffen the bracket 10. In some examples, the one or more second-wall reinforcing ribs 50 are coextensive with the one or more first-wall reinforcing ribs 48, such as being integral with each other at the corner of the bracket 10 where the first wall 16 and the second wall 22 meet. In some examples, as schematically illustrated in FIG. 3, the reinforcing ribs taper away from the corner of the bracket 10.

In some examples, brackets 10 further comprise one or more second-wall piercing ribs 58 that extend from the second-wall inner face 24 perpendicular to the first-wall inner face 18 and that taper away from the first-wall inner face 18. For example, the second-wall piercing rib(s) 58 may have a triangular or generally triangular cross-sectional profile. As a result, in assemblies 62, these second-wall piercing rib(s) 58 cut into, bite into, or otherwise extend into at least the edge of the first panel 12 and, when extending beyond the first panel 12, also into the face of the second panel 14 that engages the second-wall inner face 24. As a result, these second-wall piercing rib(s) 58 serve to restrict sliding and rotational movement of the first panel 12 and/or the second panel 14 across the second-wall inner face 24.

Similarly, in some examples, as also schematically represented in FIG. 3, brackets 10 further comprise one or more projection piercing ribs 60 that extend away from the hollow projection 30 perpendicular to the first-wall inner face 18 and that taper away from the first-wall inner face 18. As with the second-wall piercing rib(s) 58, the projection piercing rib(s) 60 may have a triangular or generally triangular cross-sectional profile. As a result, in assemblies 62, these projection piercing rib(s) 60 cut into, bite into, or otherwise extend into the surface(s) of the first panel 12 that define the first-panel projection slot 64. As a result, the projection piercing rib(s) 60 serve to restrict the first panel 12 from rotating, or otherwise moving, relative to the hollow projection 30 and thus the first wall 16. As schematically representing in FIG. 4, in some examples, the projection piercing rib(s) 60 extend from the projection upper face 40; however, projection piercing rib(s) 60 additionally or alternatively may extend from any outer surface of the hollow projection 30.

In some examples, the bracket 10 is monolithic. That is, the bracket 10 may be constructed as a single piece of material, as opposed to being an assembly of more than one piece of material. As examples, brackets 10 may be manufactured by injection-molding. Typically, brackets 10 are constructed of plastic, but they also may be constructed of composite material, such as fiber glass or other fiber-reinforced plastic material, or they may be constructed of metal, such as aluminum.

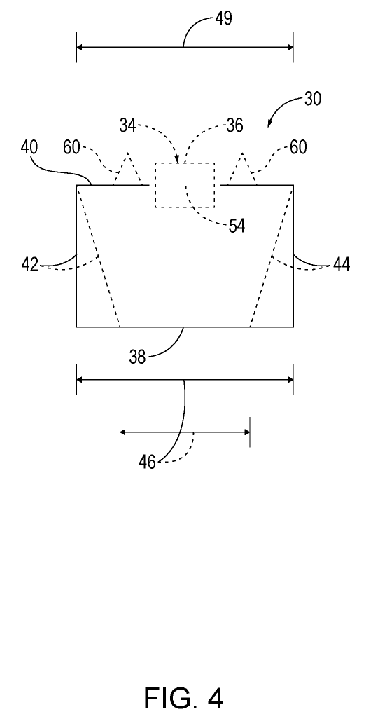

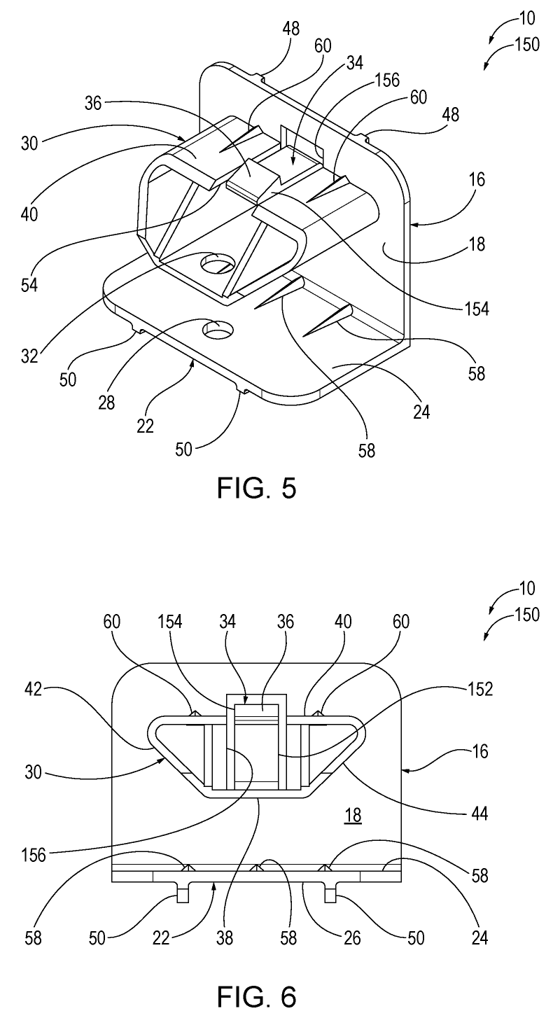

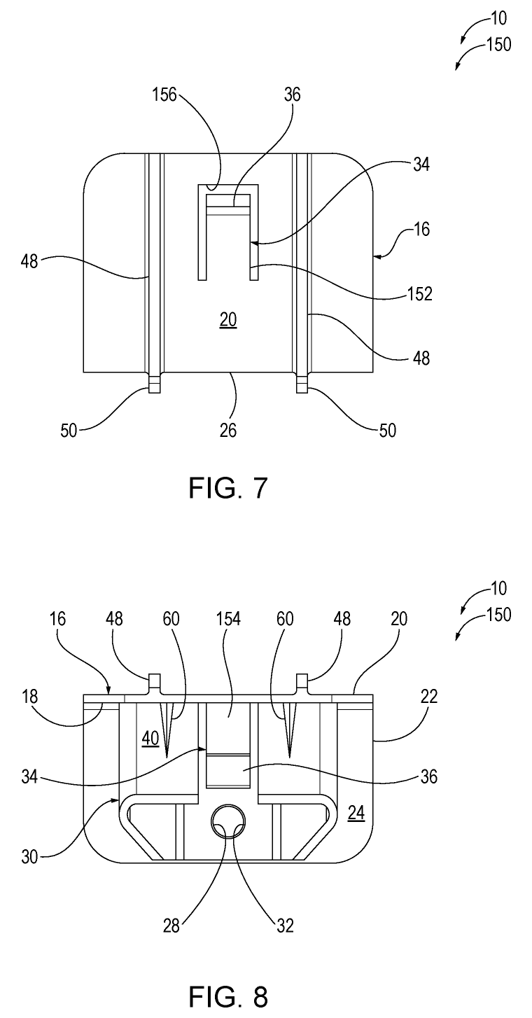

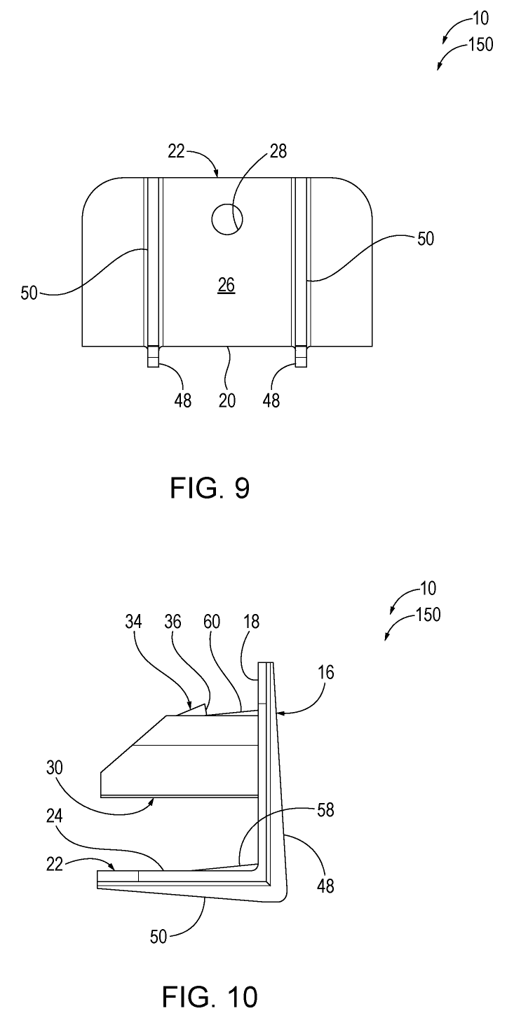

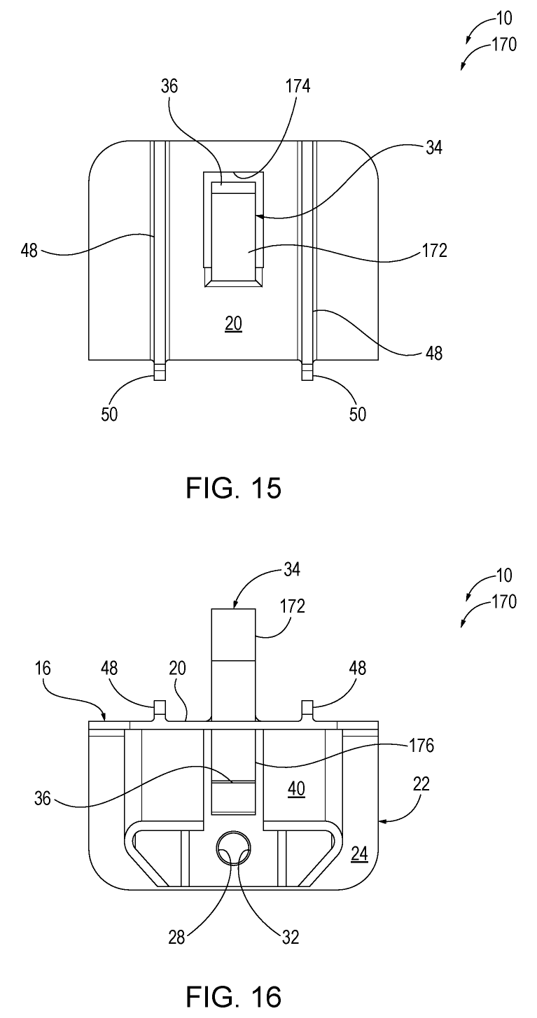

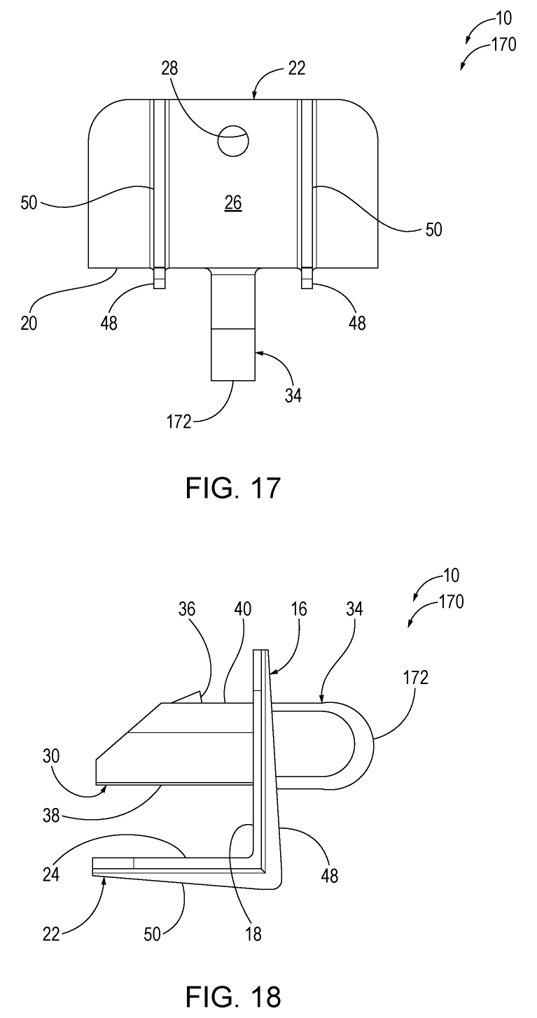

Turning now to FIGS. 5–18, illustrative non-exclusive examples of brackets 10 and assemblies 62 are illustrated. Where appropriate, the reference numerals from the schematic illustrations of FIGS. 3 and 4 are used to designate corresponding parts of the examples of FIGS. 5–18; however, the examples of FIGS. 5–18 are non-exclusive and do not limit brackets 10 and assemblies 62 to the illustrated examples. That is, brackets 10 and assemblies 62 are not limited to the specific embodiments of FIGS. 5–18, and brackets 10 and assemblies 62 may incorporate any number of the various aspects, configurations, characteristics, properties, etc. of brackets 10 and assemblies 62 that are illustrated in and discussed with reference to the schematic representations of FIGS. 3 and 4 and/or the embodiments of FIGS. 5–18, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to the embodiments of FIGS. 5–18; however, it is within the scope of the present disclosure that the previously discussed features, variants, etc. may be utilized with these embodiments.

FIGS. 5–10 illustrate a first example of a bracket 10, indicated at 150. Bracket 150 is an example of a monolithic bracket 10, whose first-wall inner face 18 is at a right angle to the second-wall inner face 24. Bracket 150 comprises a hollow projection 30 having a generally isosceles trapezoidal profile with a lower-face width that is than the upper-face width, and with a projection lower face 38 that extends further from the first-wall inner face 18 than a projection upper face 40. The projection fastener hole 32 extends through the projection lower face 38 but not through the projection upper face 40. In addition, the projection upper face 40 defines a gap 54, and bracket 150 comprises a cantilever clip 34 that has a hook 36 and that extends within the gap 54. The cantilever clip 34 of bracket 150 has a proximal portion 152 that extends along a passage 156 in the first wall 16 and is co-planar with the first wall 16 and a distal portion 154 that extends away from the proximal portion 152 within the gap 54 of the hollow projection 30. Bracket 150 comprises two first-wall reinforcing ribs 48 and two second-wall reinforcing ribs 50 that are coextensive with each other. Bracket 150 also comprises three second-wall piercing ribs 58 and two projection piercing ribs 60.

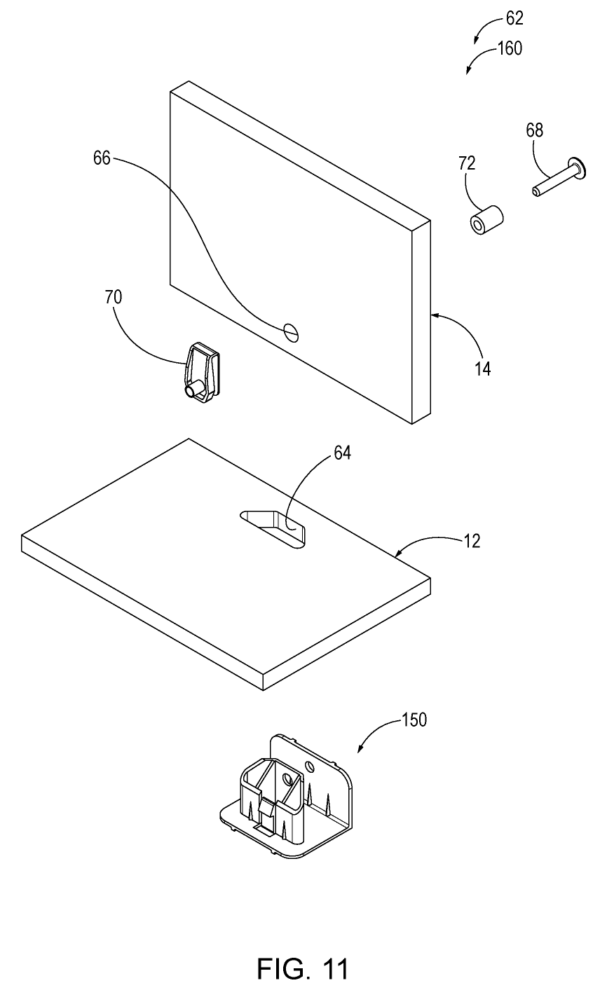

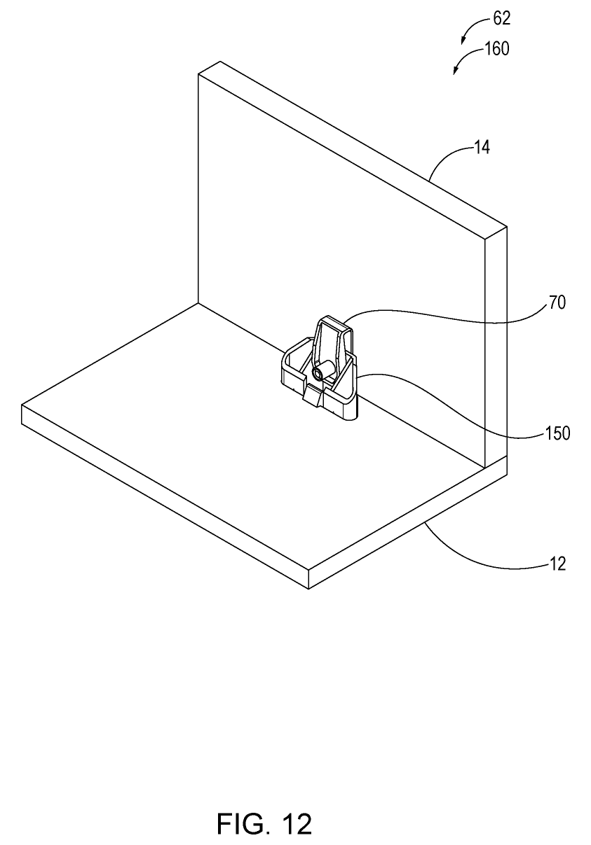

FIGS. 11 and 12 illustrate an example of an assembly 62, indicated at 160. Assembly 160 comprises bracket 150, a first panel 12, a second panel 14, a male fastener 68 in the form of a bolt, a bushing 72, and a female fastener 70 in the form of a nut clip. The nut clip extends on opposing sides of the lower wall of the hollow projection 30, positioning the female threaded portion of the nut clip for operative engagement with the male fastener 68.

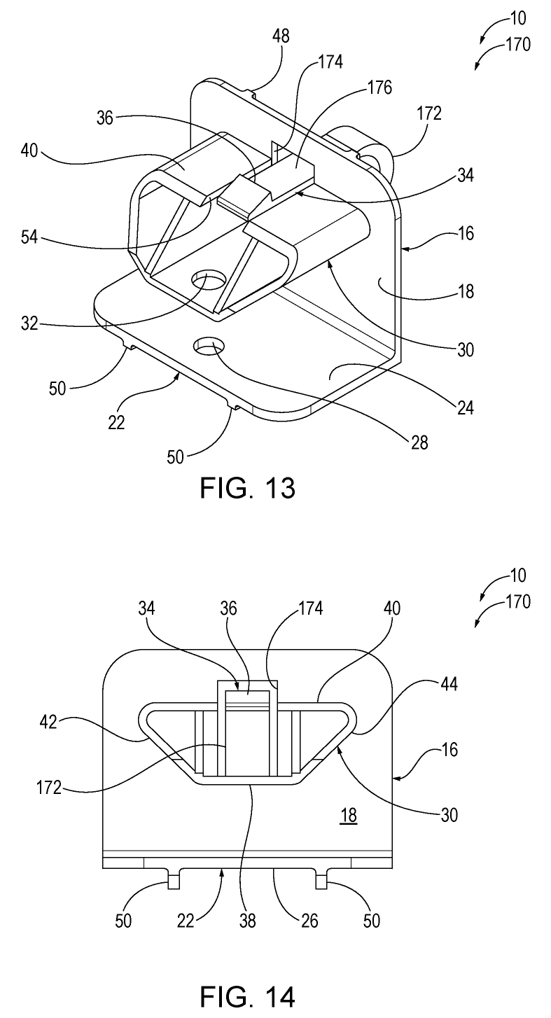

FIGS. 13–18 illustrate a second example of a bracket 10 indicted at 170. Bracket 170 is constructed similarly to bracket 150 of FIGS. 5–12; however, in bracket 170, the cantilever clip 34 has a proximal portion 172 that extends from the first-wall outer face 20 and curves back through a passage 174 defined in the first wall 16 where a distal portion 176 of the cantilever clip 34 then extends within the gap 54 of the hollow projection 30.

Illustrative, non-exclusive examples of inventive subject matter according to the present disclosure are described in the following enumerated paragraphs:

A. A bracket (10) for coupling a first panel (12) to a second panel (14) at an angle, the bracket (10) comprising:

a first wall (16) having a first-wall inner face (18) and a first-wall outer face (20) opposite the first-wall inner face (18);

a second wall (22) having a second-wall inner face (24) and a second-wall outer face (26) opposite the second-wall inner face (24), wherein the second-wall inner face (24) extends at the angle to the first-wall inner face (18), and wherein the second wall (22) defines a second-wall fastener hole (28) extending through the second wall (22); and

a hollow projection (30) extending from the first-wall inner face (18) and defining a projection fastener hole (32) extending through the hollow projection (30) and co-axially aligned with the second-wall fastener hole (28).

A1. The bracket (10) of paragraph A, further comprising a cantilever clip (34) extending away from the first-wall inner face (18).

A1.1. The bracket (10) of paragraph A1, wherein the cantilever clip (34) comprises a hook (36) extending away from the second-wall inner face (24).

A1.1.1. The bracket (10) of any of paragraphs A1–A1.1, wherein the cantilever clip (34) is configured to have a snap-fit arrangement with the first panel (12).

A2. The bracket (10) of any of paragraphs A–A1.1.1, wherein the hollow projection (30) comprises:

a projection lower face (38) facing the second-wall inner face (24);

a projection upper face (40) opposite the projection lower face (38) and facing away from the second-wall inner face (24);

a projection left face (42) extending between the projection lower face (38) and the projection upper face (40); and

a projection right face (44) opposite the projection left face (42) and extending between the projection lower face (38) and the projection upper face (40).

A2.1. The bracket (10) of paragraph A2,

wherein the projection lower face (38) has a lower-face width (46);

wherein the projection upper face (40) has an upper-face width (49); and

wherein the lower-face width (46) is less than the upper-face width (49).

A2.2. The bracket (10) of any of paragraphs A2–A2.1, wherein the projection lower face (38) extends further from the first-wall inner face (18) than the projection upper face (40).

A2.3. The bracket (10) of any of paragraphs A2–A2.2, wherein the projection fastener hole (32) extends through the projection lower face (38) but not through the projection upper face (40).

A2.4. The bracket (10) of any of paragraphs A2–A2.3, when depending from paragraph A1, wherein the cantilever clip (34) has a cantilever-clip upper face (52) that is parallel to the projection upper face (40).

A2.5. The bracket (10) of any of paragraphs A2–A2.4, when depending from paragraph A1, wherein the projection upper face (40) defines a gap (54), and wherein the cantilever clip (34) extends within the gap (54).

A2.5.1. The bracket (10) of paragraph A2.5, when depending from paragraph A1, wherein the cantilever-clip upper face (52) is co-planar with the projection upper face (40).

A3. The bracket (10) of any of paragraphs A–A2.5.1, wherein the hollow projection (30) has a generally trapezoidal profile.

A4. The bracket (10) of any of paragraphs A–A3, wherein the hollow projection (30) has a generally isosceles trapezoidal profile.

A5. The bracket (10) of any of paragraphs A–A4, further comprising one or more first-wall reinforcing ribs (48) extending from the first-wall outer face (20).

A6. The bracket (10) of any of paragraphs A–A5, further comprising one or more second-wall reinforcing ribs (50) extending from the second-wall outer face (26).

A6.1. The bracket (10) of paragraph A6, when depending from paragraph A5, wherein the one or more second-wall reinforcing ribs (50) are coextensive with the one or more first-wall reinforcing ribs (48).

A7. The bracket (10) of any of paragraphs A–A6.1, further comprising one or more second-wall piercing ribs (58) extending from the second-wall inner face (24), perpendicular to the first-wall inner face (18), and tapering away from the first-wall inner face (18).

A8. The bracket (10) of any of paragraphs A–A7, further comprising one or more projection piercing ribs (60) extending away from the hollow projection (30), perpendicular to the first-wall inner face (18), and tapering away from the first-wall inner face (18).

A8.1. The bracket (10) of paragraph A8, when depending from paragraph A3, wherein the one or more projection piercing ribs (60) extend from the projection upper face (40).

A9. The bracket (10) of any of paragraphs A–A8.1, wherein the angle is a right angle.

A10. The bracket (10) of any of paragraphs A–A9, wherein the bracket (10) is monolithic.

B. An assembly (62) comprising:

the bracket (10) of any of paragraphs A–A10;

the first panel (12) engaged with the first-wall inner face (18), wherein the first panel (12) defines a first-panel projection slot (64), through which the hollow projection (30) extends;

the second panel (14) engaged with the second-wall inner face (24), wherein the second panel (14) defines a second-panel fastener hole (66) co-axially aligned with the second-wall fastener hole (28) and the projection fastener hole (32); and

a male fastener (68) extending through the second-wall fastener hole (28), the second-panel fastener hole (66), and the projection fastener hole (32).

B1. The assembly (62) of paragraph B, further comprising a female fastener (70) operatively coupled to the hollow projection (30) and operatively mated with the male fastener (68).

B2. The assembly (62) of any of paragraphs B–B1, further comprising a bushing (72) positioned within the second-panel fastener hole (66), wherein the male fastener (68) extends through the bushing (72).

B3. The assembly (62) of any of paragraphs B–B2, wherein the first panel (12) and the second panel (14) are sandwich panels.

B3.1. The assembly (62) of paragraph B3, wherein the first panel (12) and the second panel (14) each comprise opposing face sheets (74) and a honeycomb core (76).

B4. The assembly (62) of any of paragraphs B–B3.1, wherein the hollow projection (30) has a projection profile, and wherein the first-panel projection slot (64) has a projection-hole profile that is concentric with the projection profile.

B5. The assembly (62) of any of paragraphs B–B4, when depending from paragraph A1.1, wherein the hook (36) engages the first panel (12) opposite the first-wall inner face (18).

B6. The assembly (62) of any of paragraphs B–B5, when depending from paragraph A8, wherein the one or more second-wall piercing ribs (58) extend into the first panel (12).

B6.1. The assembly (62) of paragraph B6, wherein the one or more second-wall piercing ribs (58) extend into the second panel (14).

B7. The assembly (62) of any of paragraphs B–B6.1, when depending from paragraph A9, wherein the one or more projection piercing ribs (60) extend into the first panel (12).

B8. The assembly (62) of any of paragraphs B–B7, wherein the assembly (62) defines an aerospace assembly (106).

B8.1. The assembly (62) of paragraph B8, wherein the assembly (62) defines an aircraft stowage bin (108), an aircraft closet or cabinet (110), an aircraft shelving unit (112), an aircraft crew rest compartment (114), an aircraft lavatory (116), or an aircraft interior bulkhead (118).

B9. The assembly (62) of any of paragraphs B–B8.1, wherein the assembly (62) is free of adhesive between the bracket (10) and the first panel (12) and between the bracket (10) and the second panel (14).

C. An aircraft (100), comprising a fuselage (102) defining an interior (104) and an aerospace assembly (106) positioned within the interior (104), wherein the aerospace assembly (106) comprises the assembly (62) of any of paragraphs B–B9.

D. A method of assembling the assembly (62) of any of paragraphs B–B9, the method comprising:

inserting the hollow projection (30) through the first-panel projection slot (64) such that the first panel (12) engages the first-wall inner face (18);

engaging the second panel (14) with the second-wall inner face (24) and with the first panel (12);

inserting the male fastener (68) through the second-wall fastener hole (28), the second-panel fastener hole (66), and the projection fastener hole (32); and

securing the male fastener (68) in place.

E. A method of manufacturing the bracket (10) of any of paragraphs A–A10, the method comprising injection-molding the bracket (10).

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

What is claimed is:

1. A bracket for coupling a first panel to a second panel at an angle, the bracket comprising:
a first wall having a first-wall inner face and a first-wall outer face opposite the first-wall inner face;
a second wall having a second-wall inner face and a second-wall outer face opposite the second-wall inner face, wherein the second-wall inner face extends at the angle to the first-wall inner face, and wherein the second wall defines a second-wall fastener hole extending through the second wall; and
a hollow projection extending from the first-wall inner face and defining a projection fastener hole extending through the hollow projection and co-axially aligned with the second-wall fastener hole.

2. The bracket of claim 1, further comprising a cantilever clip extending away from the first-wall inner face.

3. The bracket of claim 1, wherein the hollow projection comprises:
a projection lower face facing the second-wall inner face and having a lower-face width;
a projection upper face opposite the projection lower face and facing away from the second-wall inner face and having an upper-face width, wherein the lower-face width is less than the upper-face width;
a projection left face extending between the projection lower face and the projection upper face; and
a projection right face opposite the projection left face and extending between the projection lower face and the projection upper face.

4. The bracket of claim 1, wherein the hollow projection comprises:
a projection lower face facing the second-wall inner face;
a projection upper face opposite the projection lower face and facing away from the second-wall inner face, wherein the projection lower face extends further from the first-wall inner face than the projection upper face;
a projection left face extending between the projection lower face and the projection upper face; and
a projection right face opposite the projection left face and extending between the projection lower face and the projection upper face.

5. The bracket of claim 1,
wherein the hollow projection comprises:
a projection lower face facing the second-wall inner face;
a projection upper face opposite the projection lower face and facing away from the second-wall inner face;
a projection left face extending between the projection lower face and the projection upper face; and
a projection right face opposite the projection left face and extending between the projection lower face and the projection upper face; and
wherein the projection fastener hole extends through the projection lower face but not through the projection upper face.

6. The bracket of claim 1, further comprising a cantilever clip extending away from the first-wall inner face;
wherein the hollow projection comprises:
a projection lower face facing the second-wall inner face;
a projection upper face opposite the projection lower face and facing away from the second-wall inner face, wherein the projection upper face defines a gap, and wherein the cantilever clip extends within the gap;
a projection left face extending between the projection lower face and the projection upper face; and
a projection right face opposite the projection left face and extending between the projection lower face and the projection upper face.

7. The bracket of claim 1, wherein the hollow projection has a generally trapezoidal profile.

8. The bracket of claim 1, further comprising one or more second-wall piercing ribs extending from the second-wall inner face, perpendicular to the first-wall inner face, and tapering away from the first-wall inner face.

9. The bracket of claim 1, further comprising one or more projection piercing ribs extending away from the hollow projection, perpendicular to the first-wall inner face, and tapering away from the first-wall inner face.

10. The bracket of claim 1, wherein the angle is a right angle.

11. The bracket of claim 1, wherein the bracket is monolithic.

12. An assembly comprising:
the bracket of claim 1;
the first panel engaged with the first-wall inner face, wherein the first panel defines a first-panel projection slot, through which the hollow projection extends;
the second panel engaged with the second-wall inner face, wherein the second panel defines a second-panel fastener hole co-axially aligned with the second-wall fastener hole and the projection fastener hole; and
a male fastener extending through the second-wall fastener hole, the second-panel fastener hole, and the projection fastener hole.

13. The assembly of claim 12, further comprising a female fastener operatively coupled to the hollow projection and operatively mated with the male fastener.

14. The assembly of claim 12, further comprising a bushing positioned within the second-panel fastener hole, wherein the male fastener extends through the bushing.

15. The assembly of claim 12, wherein the first panel and the second panel are sandwich panels.

16. The assembly of claim 15, wherein the first panel and the second panel each comprise opposing face sheets and a honeycomb core.

17. The assembly of claim 12, wherein the hollow projection has a projection profile, and wherein the first-panel projection slot has a projection-hole profile that is concentric with the projection profile.

18. The assembly of claim 12, wherein the assembly defines an aircraft stowage bin, an aircraft closet or cabinet, an aircraft shelving unit, or an aircraft crew rest compartment.

19. A method of assembling the assembly of claim 12, the method comprising:
inserting the hollow projection through the first-panel projection slot such that the first panel engages the first-wall inner face;
engaging the second panel with the second-wall inner face and with the first panel;
inserting the male fastener through the second-wall fastener hole, the second-panel fastener hole, and the projection fastener hole; and
securing the male fastener in place.

20. A method of manufacturing the bracket of claim 1, the method comprising:
injection-molding the bracket.
